(19) United States
(12) Patent Application Publication
(10) Pub. No.: US 2025/0296287 A1
(43) Pub. Date: Sep. 25, 2025

(54) FILTER MOLDING

(71) Applicant: TRINAMIX GMBH, Ludwigshafen Am Rhein (DE)

(72) Inventors: Christoph PROKOP, Ludwigshafen am Rhein (DE); Wei-Shan WANG, Ludwigshafen am Rhein (DE); Sebastian VALOUCH, Ludwigshafen am Rhein (DE)

(21) Appl. No.: 18/861,944

(22) PCT Filed: May 23, 2023
(86) PCT No.: PCT/EP23/63731

§ 371 Date: Oct. 31, 2024

(30) Foreign Application Priority Data
May 24, 2022 (EP) 22175046.6
Dec. 14, 2022 (EP) 22213427.2

(51) Int. Cl. B29D 11/00

(52) U.S. Cl. CPC B29D 11/00634; B29D 11/0073

(57) ABSTRACT

Disclosed herein is a method for manufacturing an optical filter unit for a spectrometer device. The method includes:
a) providing at least one layer of a filter material;
b) generating individual filter pieces by singulating the layer of filter material (126) into filter pieces;
c) providing a carrier;
d) picking the individual filter pieces and placing them on the carrier;
e) molding at least one moldable material at least partially onto the carrier with the individual filter pieces, thereby generating at least one molded structure with a predefined aperture and a predefined pitch between the individual filter pieces;
f) removing the carrier to generate a molded filter assembly; and
g) singulating the molded filter assembly into the at least one optical filter unit.

Also described herein are an optical detector and a spectrometer device.

### TECHNICAL FIELD

The invention relates to a method for manufacturing at least one optical filter unit that may, preferably, be configured for contributing to optical detection of electromagnetic radiation in an optical detector, which may, preferably, be comprised by a spectrometer device. Furthermore, the invention relates to an optical detector for an optical detection of electromagnetic radiation and to a spectrometer device. Such methods and devices can, in general, be employed in various areas of optical sensing and detecting technology, such as in a professional environment, for example in devices for medical and physiological diagnostics and research, as well as in devices used for quality control and in various other fields of scientific research. Further applications are possible, such as in consumer electronics and household devices, specifically in portable and handheld devices. However, even further applications are feasible.

### BACKGROUND ART

Optical detectors in general respond to electromagnetic radiation in a specific wavelength range depending on the material composition of the detector. To limit the spectral response to a desired wavelength range, optical bandpass filters, especially optical narrow bandpass filters, are used, which can be based on optical interference. Characteristics of optical bandpass filters are an optical blocking of unwanted wavelength ranges, thereby defining the bandwidth of the desired wavelength range. For obtaining different wavelength ranges, different optical bandpass filters are typically required.

However, known methods for manufacturing optical filters exhibit various disadvantages. Especially, a material layer to be used for the optical filter is cut into a plurality of tiny filter pieces, such as having an area of approx. 0.5 mm×0.5 mm. Subsequently, each filter piece has to be fixed mechanically with good precision in order to arrange with the small optical system having a narrow extension. Herein, picking and placing the plurality filters of the tiny filter pieces is sophisticated and expensive in mass production, especially owing to high effort and long processing time required for such a manufacturing step. Similarly, high effort and long processing times are also required for quality inspections, e.g. checking the correct positioning of these individually mechanically fixed and arranged tiny filter pieces.

Further, as a consequence of the cutting of the material layer into the plurality filters of the tiny filter pieces, an individual optical filter often does not exhibit clear edges, but rather shows chipped edges. However, chipped edges typically result in optically non-usable areas, e.g. in low and unclear apertures, which are prone to cause undesired optical effects, such as transmission, reflection and/or scattering of light, specifically outside the desired wavelength range.

### PROBLEM TO BE SOLVED

It is therefore desirable to provide methods and devices that at least substantially avoid the disadvantages of known methods and devices. In particular, it would be desirable having a method for manufacturing at least one optical filter unit that could suppress such adverse effects when assembling the tiny filters pieces.

### SUMMARY

This problem is addressed by a method for manufacturing at least one optical filter unit, by an optical detector and by a spectrometer device with the features of the independent claims. Advantageous embodiments which might be implemented in an isolated fashion or in any arbitrary combinations are listed in the dependent claims as well as throughout the specification.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, notwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect, the present invention relates to a method for manufacturing at least one optical filter unit for a spectrometer device. The method may also be referred to as “manufacturing method”. The method comprises the following method steps that may be performed in the given order. However, different order may also be possible. Further, one, more than one or even all of the method steps may be performed once or repeatedly. Furthermore, the method steps may be performed successively or, alternatively, two or more method steps may be performed in a timely overlapping fashion or even in parallel. The method may further comprise additional method steps that are not listed.

The method comprises the following steps:

a) providing at least one layer of a filter material;

b) generating individual filter pieces by singulating the layer of filter material into filter pieces;

c) providing a carrier;

d) picking the individual filter pieces and placing them on the carrier;

e) molding at least one moldable material at least partially onto the carrier with the individual filter pieces, thereby generating at least one molded structure with a predefined aperture and a predefined pitch between the individual filter pieces;

f) removing the carrier to generate a molded filter assembly; and

g) singulating the molded filter assembly into the at least one optical filter unit.

The optical filter unit may specifically be configured for contributing to an optical detection performed by a spectrometer device and thus, the optical filter unit may be manufactured to be integrable into a spectrometer device. Specifically, the optical filter unit may be manufactured for the purpose of becoming a part of a spectrometer device.

The term “spectrometer device” as used herein is a broad term and is to be given its ordinary and customary meaning to a person of ordinary skill in the art and is not to be limited to a special or customized meaning. The term specifically may refer, without limitation, to a device for acquiring at least one item of spectral information on at least one object by using electromagnetic radiation. Specifically, the at least one item of spectral information may refer to at least one optical property or optically measurable property that is determined as a function of a wavelength, for one or more different wavelengths of the electromagnetic radiation. More specifically, the at least one item of spectral information may relate to at least one property characterizing at least one of a transmission, an absorption, a reflection and an emission of the at least one object. The at least one optical property, may be determined for one or more wavelengths of the electromagnetic radiation.

The term “filter material”, as used herein is a broad term and is to be given its ordinary and customary meaning to a person of ordinary skill in the art and is not to be limited to a special or customized meaning. The term specifically may refer, without limitation, to a sheet and/or panel of coherent material having optical filtering properties. In particular, the filter material may be configured for reflecting and/or blocking electromagnetic radiation, i.e. light, of unwanted wavelength ranges from transmitting through the material.

The term “singulating” as used herein is a broad term and is to be given its ordinary and customary meaning to a person of ordinary skill in the art and is not to be limited to a special or customized meaning. The term specifically may refer, without limitation, to a process of separating a coherent material into a plurality of segregated individual parts. In particular, the layer of filter material may be singulated into individual filter pieces by separating and/or disconnecting the coherent filter material into a plurality of segregated individual filter pieces.

Specifically, the individual filter pieces, specifically in step b), may be singulated to have at least one predefined dimension. Thus, the individual filter pieces, singulated, e.g. separated, from the layer of filter material, may have at least one predefined dimension, such as a predefined form and/or shape. As an example, the individual filter pieces may be singulated into rectangular or triangular pieces, e.g. having a predefined width and length.

In particular, specifically in step b), the individual filter pieces may be singulated by using at least one singulation method. As an example, the at least one singulation method may be selected from at least one of: mechanical dicing, e.g. sawing and/or cutting; laser dicing; plasma dicing; scribing and breaking. Thus, the process of singulating may also be referred to as dicing and/or scribing.

The term “carrier” as used herein is a broad term and is to be given its ordinary and customary meaning to a person of ordinary skill in the art and is not to be limited to a special or customized meaning. The term specifically may refer, without limitation, to a solid and/or rigid structure, specifically a planar structure, configured for providing mechanical support. The carrier may specifically be or may comprise a substrate material, such as glass and/or epoxy. Other materials, for example plastic materials, are possible.

The providing of the carrier in step c) may further comprise generating the carrier by laminating a foil on a layer of carrier material. Thus, in particular, step c) may further comprise laminating a foil, such as a carrier foil, onto a carrier layer material, i.e. comprising the substrate material, and thereby generating the carrier. The carrier material may specifically be provided in form of at least one wafer and a panel. Additionally or alternatively, the foil, i.e. the carrier foil, may comprise at least one release material. The release material of the carrier foil may specifically be configured to allow for a non-destructive separation of the carrier and the molded structure when removing the carrier in step f).

Step d) comprises performing a pick and place process in which the individual filter pieces are picked up and then placed on the carrier. The term “pick and place” as used herein is a broad term and is to be given its ordinary and customary meaning to a person of ordinary skill in the art and is not to be limited to a special or customized meaning. The term specifically may refer, without limitation, to an automated process of taking an element from one location, moving the element at another location and locating it there. In particular, the pick and place process may be or may comprise handling at least one element by transferring the element from one location to another location, such as to a location individually assigned to that specific element. Thus, step d) may comprise transferring the individual filter pieces from a pick-up location to a location on the carrier specifically assigned to the individual filter piece that is handled. The pick and place process may particularly be performed automatically by one or more of a robot, such as an industrial robot, and a surface-mount technology (SMT) component placement system.

In step d), at least two individual filter pieces may be placed on the carrier. Specifically, at least three segregated individual filter pieces may be placed on the carrier in step d). More specifically, in step d) of the manufacturing method, a plurality of individual filter pieces may be placed on the carrier. In particular, the placing of these two, three or even more individual filter pieces in step d) may be performed by iteratively performing the pick and place process as described above or as further outlined below.

In particular, the individual filter pieces may be placed on the carrier, specifically on the carrier foil, in a predefined arrangement and at a predefined distance between the individual filter pieces. Additionally or alternatively, each individual filter piece may be arranged at a predefined location on the carrier, specifically on the carrier foil.

In step e), at least one molded structure, for example a support structure, is generated by molding at least one moldable material at least partially onto the carrier with the individual filter pieces, i.e. onto the carrier having the individual filter pieces placed thereon. Specifically, the molded structure may be molded onto the carrier such that the molded structure mechanically stabilizes the individual filter pieces, i.e. providing support by forming a form fitting closure at least partially around at least one part of each of the individual filter pieces.

The term “molding” as used herein is a broad term and is to be given its ordinary and customary meaning to a person of ordinary skill in the art and is not to be limited to a special or customized meaning. The term specifically may refer, without limitation, to a process of transferring and shaping a malleable and curable material into a desired form and/or built. The molding may specifically be performed by using a mold cavity and/or die, such as in one or more of an injection molding process and a compression molding process, and/or by free forming, such as in a selective melting process, thereby generating the molded structure with predefined aperture and predefined pitch between the individual filter pieces. Specifically, the molded structure may exhibit the predefined aperture after curing, i.e. when the moldable material, such as the malleable material, has been transformed into a cured and/or hardened state.

The term “predefined aperture”, as used herein is a broad term and is to be given its ordinary and customary meaning to a person of ordinary skill in the art and is not to be limited to a special or customized meaning. The term specifically may refer, without limitation, to a width and depth of an opening formed by the molded structure, i.e. around the individual filter pieces, the width and depth corresponding to a previously determined and/or previously set width and depth. The previously determined and/or previously set width and depth may for example be provided in a lookup table or the like when starting performing the manufacturing method. As an example, in case the molding is performed by using an injection molding process, the predefined and/or desired aperture of the molded structure is reflected and/or present, e.g. taking into account material shrinking properties, in the shape of the mold cavity.

The term “predefined pitch”, as used herein is a broad term and is to be given its ordinary and customary meaning to a person of ordinary skill in the art and is not to be limited to a special or customized meaning. The term specifically may refer, without limitation, to a distance between openings in the molded structure formed around neighboring individual filter pieces, the distance corresponding to a previously determined and/or previously set distance. The previously determined and/or previously set distance may for example be provided in a lookup table or the like when starting performing the manufacturing method. As an example, in case the molding is performed by using an injection molding process, the predefined and/or desired pitch of the molded structure is reflected and/or present, e.g. taking into account material shrinking properties, in the shape of the mold cavity.

In particular, the molding process may be selected from at least one of: cavity molding; e.g. injection molding and/or compression molding; selective melting, e.g. selective laser melting; and exposed die molding, such as a transfer molding, e.g. in combination with a dynamic clamping. Thus, as an example, the molding may be or may comprise an injection molding process and/or a compression molding process. Therein, as an example, a die and/or cavity at least partially enclosing a space to be occupied by the moldable material may be provided and the moldable material may then be transferred into the die and/or cavity. Additionally or alternatively, the molding may be or may comprise a selective laser melting process, e.g. performed by filling the space to be occupied by the moldable material with grains and/or pellets of unmelted moldable material and then selectively melting individual moldable material grains or pellets such as to melt together and form the molded structure. Additionally or alternatively, the molding may be or may comprise an exposed die encapsulation process, as e.g. known from typical IC packaging and/or flip-chip production, optionally enhanced by dynamically clamping a counter-carrier onto the moldable material, e.g. for compacting purposes.

Between steps f) and g), the method may comprise the following further step:

h) molding at least one moldable material onto a side of the filter pieces previously covered by the carrier, thereby generating at least one second molded structure with a predefined aperture and a predefined pitch between the individual filter pieces.

Thus, the method may comprise performing a double-sided molding. In particular, the second molded structure may be a mirror image of the first molded structure, i.e. the one or more apertures of the second molded structure may equal, within manufacturing tolerances, the one or more apertures of the first molded structure. Alternatively, at least one of the one or more apertures of the second molded structure may intentionally differ from the one or more apertures of the first molded structure.

As an example, the method, specifically before step h), may comprise the following still further step:

i) flipping the molded structure with the individual filter pieces as generated in step e).

Thus, the method may comprise turning the first molded structure, with the individual filter pieces arranged at least partially therein, upside down, i.e. turning the first molded structure and the filter pieces ±180° within a tolerance of ±1°, around at least one axis, before generating the second molded structure.

The molded structure, specifically one or more of the first molded structure and the second molded structure, may be configured for at least one of blocking and absorbing electromagnetic radiation having a wavelength λ of 300 nm≤λ≤10 μm. Specifically, the molded structure may be configured for at least one of blocking and absorbing electromagnetic radiation having a wavelength λ of 500 nm≤λ≤6 μm. More specifically, e.g. in case an envisaged detector material, such as a material of a detector pixel, comprises PbSe, the molded structure, specifically one or more of the first molded structure and the second molded structure, may be configured for at least one of blocking and absorbing electromagnetic radiation having a wavelength λ of 1 λm≤λ≤5 μm. More specifically, e.g. in case an envisaged detector material, such as a material of a detector pixel, comprises PbS, the molded structure, specifically one or more of the first molded structure and the second molded structure, may be configured for at least one of blocking and absorbing electromagnetic radiation having a wavelength of 1 λm≤λ≤3 λm. As an example, the molded structure, outside of the above-described ranges, may be configured to block electromagnetic radiation with a radiation blocking grade of at least OD2, specifically at least OD3, more specifically at least OD4.

At least one molded structure, specifically both molded structures, may at least partially enclose and/or cover the individual filter pieces. Particularly, the at least one molded structure, specifically both molded structures together and/or jointly, may cover potentially ragged and/or splintered, e.g. chipped, edges of the individual filter pieces.

In a further aspect, the present invention relates to an optical detector for an optical detection of electromagnetic radiation in a predefined wavelength range of interest. The optical detector comprises at least one detector pixel and at least one optical filter unit being manufactured as described elsewhere in this document, i.e. as outlined above or as described in further detail below. Thus, specifically with regard to the definition of terms, reference may be made to the description of the method for manufacturing at least one optical filter unit, specifically of the manufacturing method.

In a yet further aspect, the present invention relates to a spectrometer device. The spectrometer device comprises
at least one optical detector according to any one of the preceding claims referring to the optical detector; and
at least one evaluation device configured to generate at least one item of spectral information from at least one detector signal generated by the at least one optical detector from incident radiation.

The described methods and devices have considerable advantages over the prior art. Thus, in particular, the present methods and devices may allow for reducing the risk of erroneous measurements by increasing accuracy and precision of spectroscopic measurements. In particular, the present methods and devices, e.g. by the one or more molded structures at least partially encircling individual filter pieces, may increase measurement precision by avoiding undesired optical effects, such as transmission, reflection and/or scattering of light, i.e. outside of a desired wavelength range.

Further, the present methods and devices may allow for a more efficient and resource conserving manufacturing of spectrometer devices. As an example, the present methods and devices, e.g. the applied molding process, i.e. a combination of selective molding, exposed die molding and double side molding, may be advantageous by allowing a mechanical fixing of the filter pieces and providing a subassembly, especially for facilitating further processing. Further, the present methods and devices, e.g. the applied molding process and/or its combination, may be particularly advantageous by allowing to only cover the chipped filter edges of the optical filter, but not a considerable portion of the filter surface and by allowing to provide a defined clear aperture to the plurality of the filter pieces, preferably to each filter piece. Furthermore, the present methods and devices may avoid a passage of light, which does not have not desired wavelength, especially owing to transmission, reflection, and/or scattering at the chipped filter edges. Furthermore, the present methods and devices may be suitable for mass production. In addition, the optical filter unit manufactured according to the method as described herein may allow for a smaller, more compactly built spectrometer device.

Summarizing and without excluding further possible embodiments, the following embodiments may be envisaged:

Embodiment 1. A method for manufacturing at least one optical filter unit for a spectrometer device, the method comprising:

a) providing at least one layer of a filter material;

b) generating individual filter pieces by singulating the layer of filter material into filter pieces;

c) providing a carrier;

d) picking the individual filter pieces and placing them on the carrier;

e) molding at least one moldable material at least partially onto the carrier with the individual filter pieces, thereby generating at least one molded structure with a predefined aperture and a predefined pitch between the individual filter pieces;

f) removing the carrier to generate a molded filter assembly; and

g) singulating the molded filter assembly into the at least one optical filter unit.

Embodiment 2. The method according to the preceding embodiments, wherein the individual filter pieces, specifically in step b), are singulated to have at least one predefined dimension.

Embodiment 3. The method according to any one of the preceding embodiments, wherein, specifically in step b), the individual filter pieces are singulated by using at least one singulation method.

Embodiment 4. The method according to the preceding embodiment, wherein the at least one singulation method is selected from at least one of: mechanical dicing, e.g. sawing and/or cutting; laser dicing; plasma dicing; scribing and breaking.

Embodiment 5. The method according to any one of the preceding embodiments, wherein step c) comprises generating the carrier by laminating a foil on a layer of carrier material.

Embodiment 6. The method according to the preceding embodiment, wherein the foil comprises at least one release material configured to allow a non-destructive separation of the carrier and the molded structure when removing the carrier in step f).

Embodiment 7. The method according to any one of the two preceding embodiments, wherein the carrier material is provided in form of at least one of a wafer and a panel.

Embodiment 8. The method according to any one of the preceding embodiments, wherein in step d) at least two, specifically at least three, more specifically a plurality of, individual filter pieces are placed on the carrier.

Embodiment 9. The method according to any one of the preceding embodiments, wherein the individual filter pieces are placed on the carrier, specifically on the carrier foil, in a predefined arrangement and at a predefined distance between the individual filter pieces.

Embodiment 10. The method according to any one of the preceding embodiments, wherein each individual filter piece is arranged at a predefined location on the carrier, specifically on the carrier foil.

Embodiment 11. The method according to any one of the preceding embodiments, wherein the molding process is selected from at least one of: cavity molding; e.g. injection molding and/or compression molding; selective melting, e.g. selective laser melting; and exposed die molding, such as a transfer molding, e.g. in combination with a dynamic clamping.

Embodiment 12. The method according to any one of the preceding embodiments, wherein between steps f) and g) the method further comprises:

h) molding at least one moldable material onto a side of the filter pieces previously covered by the carrier, thereby generating at least one second molded structure with a predefined aperture and a predefined pitch between the individual filter pieces.

Embodiment 13. The method according to the preceding embodiment, wherein before step h) the method further comprises:

i) flipping the molded structure with the individual filter pieces as generated in step e).

Embodiment 14. The method according to any one of the preceding embodiments, wherein the molded structure is configured for at least one of blocking and absorbing electromagnetic radiation having a wavelength λ of 300 nm≤λ≤10 μm, specifically 500 nm≤λ≤6 μm, more specifically 1 μm≤λ≤5 μm, more specifically of 1 μm ≤λ≤3 μm.

Embodiment 15. The method according to any one of the preceding embodiments, wherein the at least one molded structure, specifically both molded structures, at least partially encloses the individual filter pieces.

Embodiment 16. The method according to the preceding embodiment, wherein the at least one molded structure, specifically both molded structures together and/or jointly, covers potentially ragged and/or splintered, e.g. chipped, edges of the individual filter pieces.

Embodiment 17. An optical detector for an optical detection of electromagnetic radiation in a predefined wavelength range of interest, the optical detector comprising
at least one detector pixel; and
at least one optical filter unit being manufactured according to any one of the preceding embodiments.

Embodiment 18. A spectrometer device comprising
at least one optical detector according to any one of the preceding embodiments referring to the optical detector; and
at least one evaluation device configured to generate at least one item of spectral information from at least one detector signal generated by the at least one optical detector from incident radiation.

### SHORT DESCRIPTION OF THE FIGURES

Further optional features and embodiments will be disclosed in more detail in the subsequent description of embodiments, preferably in conjunction with the dependent claims. Therein, the respective optional features may be implemented in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 shows a schematic illustration of an embodiment of a spectrometer device comprising an optical detector with an optical filter unit;

FIGS. 2a and 2b show different flow charts of a method for manufacturing at least one optical filter unit for a spectrometer device; and

FIGS. 3a to 3c show different embodiments of an optical filter unit in a perspective view (FIG. 3a) and in cross section views (FIGS. 3b and 3c);

FIGS. 4 to 7 show different schematic illustrations of different steps of a method for manufacturing at least one optical filter unit for a spectrometer device.

### DETAILED DESCRIPTION OF THE EMBODIMENTS

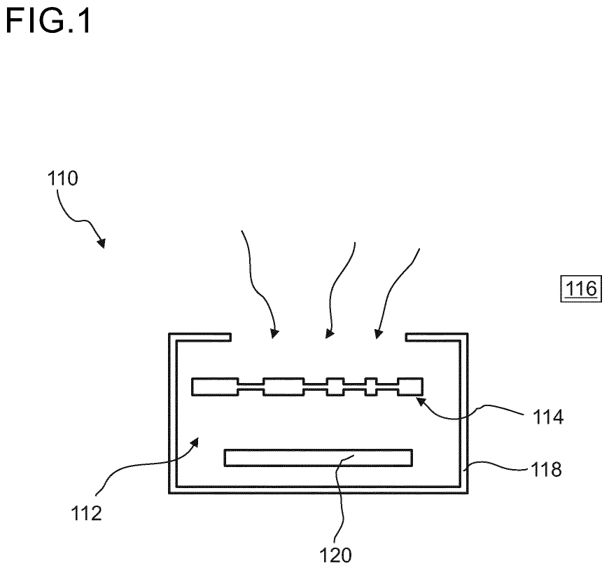

In FIG. 1, a schematic illustration of an embodiment of a spectrometer device 110 is illustrated, the spectrometer device 110 comprising an optical detector 112, wherein the optical detector comprises an optical filter unit 114. The spectrometer device 110, in addition to the optical detector 112, comprises at least one evaluation device 116 configured to generate at least one item of spectral information from at least one detector signal generated by the at least one optical detector 112 from incident radiation. In FIG. 1, the incident radiation and their direction is schematically illustrated by arrows. As an example, the spectrometer device 110 may comprise a housing 118 at least partially enclosing the optical detector 112 with the optical filter unit 114. The optical detector 112 configured for an optical detection off electromagnetic radiation in a predefined wavelength range of interest, in addition to the optical filter unit 114, comprises at least one detector pixel 120.

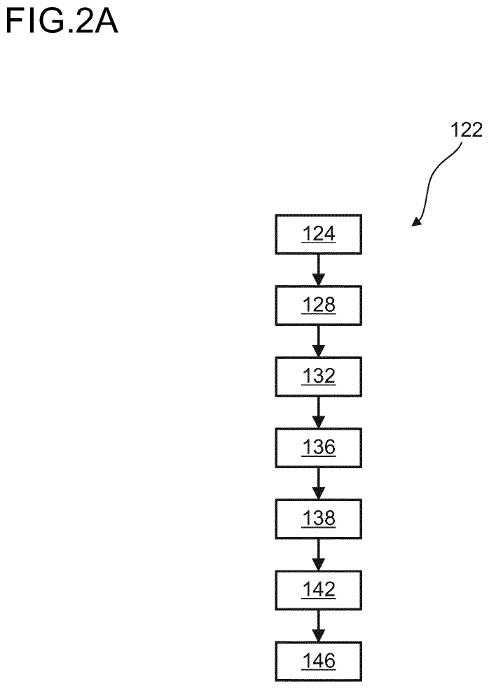

The optical filter unit 114 may be manufactured by a method for manufacturing an optical filter unit 114 for a spectrometer device 110, i.e. by a manufacturing method 122. A flowchart of a method for manufacturing an optical filter unit 114 for a spectrometer device 110 is illustrated in FIG. 2a. The manufacturing method 122 comprises at least the following steps:

a) (denoted by reference number 124) providing at least one layer of a filter material 126;

b) (denoted by reference number 128) generating individual filter pieces 130 by singulating the layer of filter material 126 into filter pieces;

c) (denoted by reference number 132) providing a carrier 134;

d) (denoted by reference number 136) picking the individual filter pieces 130 and placing them on the carrier 134;

e) (denoted by reference number 138) molding at least one moldable material at least partially onto the carrier 134 with the individual filter pieces 130, thereby generating at least one molded structure 140 with a predefined aperture and a predefined pitch between the individual filter pieces 130;

f) (denoted by reference number 142) removing the carrier 134 to generate a molded filter assembly 144; and

g) (denoted by reference number 146) singulating the molded filter assembly 144 into the at least one optical filter unit 114.

As an example, the manufacturing method 122 may further comprise the step h) (denoted by reference number 148) of molding at least one moldable material onto a side of the filter pieces 130 previously covered by the carrier 134, thereby generating at least one second molded structure 140 with a predefined aperture and a predefined pitch between the individual filter pieces 130. Step h) may specifically be performed between steps f) and g). Further, the manufacturing method 122 may comprise step i) (denoted by reference number 150) of flipping the molded structure 140 with the individual filter pieces 130 as generated in step e) 138. Step i) may specifically be performed before step h). A flow chart of a method for manufacturing an optical filter unit 114 for a spectrometer device 110 comprising steps h) 148 and i) 150 is illustrated in FIG. 2b.

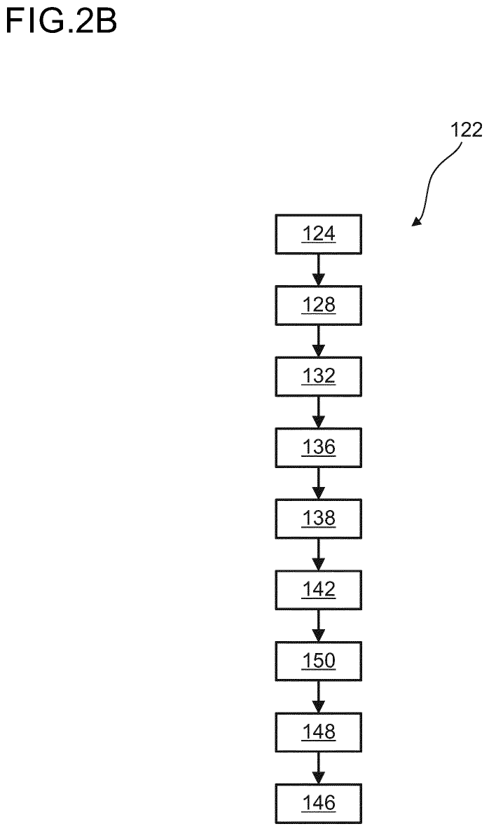

Different embodiments of an optical filter unit 114 manufactured by performing the manufacturing method 122 are illustrated in FIGS. 3a, 3b and 3c. The optical filter unit 114 comprises the individual filter pieces 130 within the at least one molded structure 140. In particular, a predefined aperture, for example a predefined opening over each of the individual filter pieces 130, is formed by the at least one molded structure 140. Further, the at least one molded structure 140 also ensures a predefined pitch, for example a predefined distance, between the individual filter pieces 130.

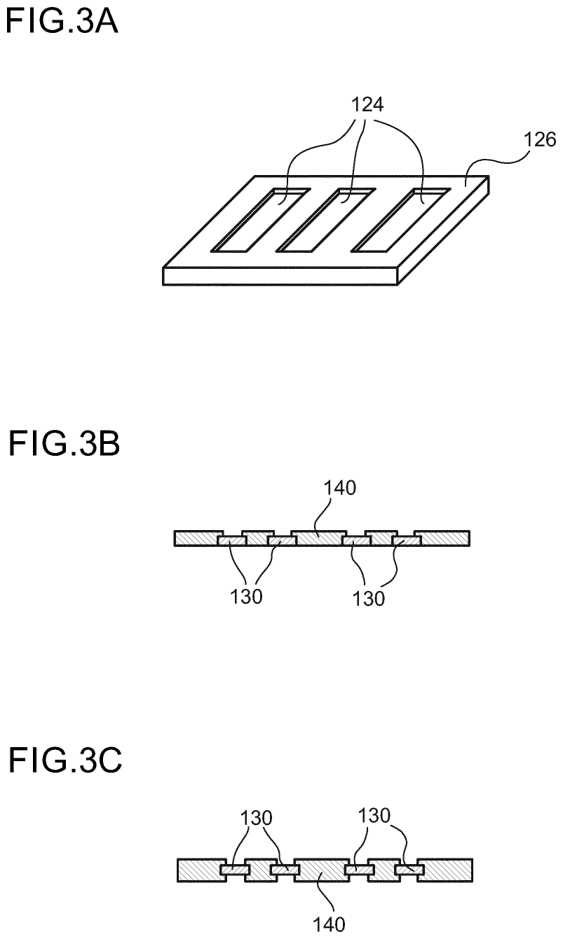

FIGS. 4 to 8 show different schematic illustrations of steps of a method for manufacturing at least one optical filter unit 114 for a spectrometer device 110, i.e. of the manufacturing method 122.

As an example, FIG. 4 exemplarily illustrates the performance of step b), wherein the individual filter pieces 130 are generated by singulating the layer of filter material 126. In particular, the layer of filter material 126 may be singulated into predefined dimensions, by mechanical dicing, laser dicing, scribing, or any other singulation method i.e. as outlined above. In FIG. 4, the dashed lines indicate a singulation path, such as a cutting and/or dicing line.

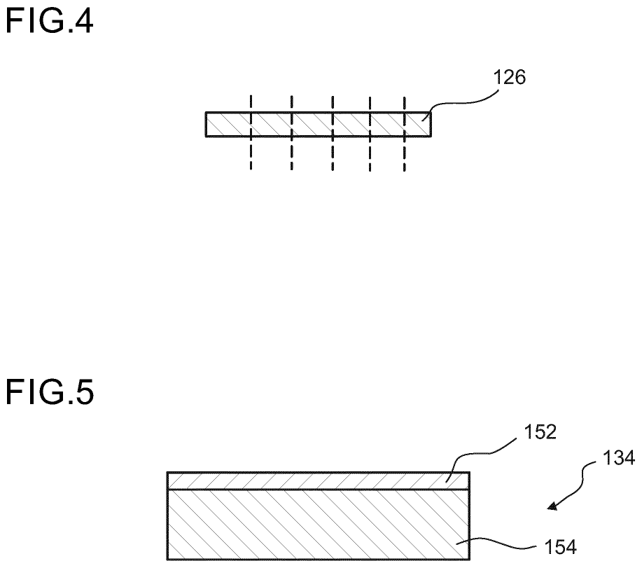

Further, the carrier 134 as provided in step c), may, for example, comprise a foil 152, such as a carrier foil, e.g. comprising at least one release material, laminated on a layer of carrier material 154. Such a carrier 134, i.e. generated by laminating a foil 152 on a layer of carrier material 154, is exemplarily illustrated in FIG. 5.

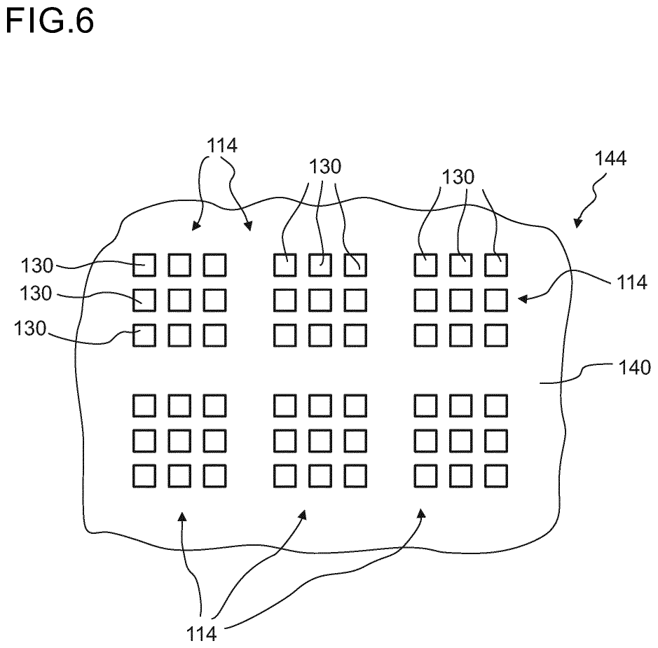

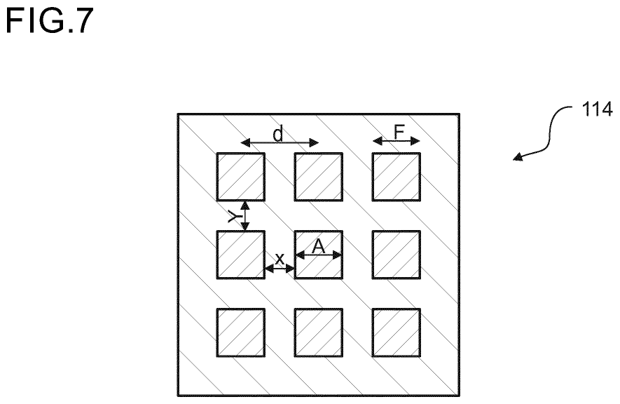

FIG. 6 exemplarily illustrates, in a top plane view, a molded filter assembly 144, as generated in step f). The molded filter assembly 144, specifically in subsequent step g), may then be singulated into a plurality of optical filter unit 114. For example, the molded filter assembly 144 illustrated exemplarily in FIG. 6, may be singulated into six optical filter units 114. One such optical filter unit 114 is exemplarily illustrated in FIG. 7, in a cross sectional view parallel to the top plane view illustrated in FIG. 6. Therein, as an example, “d” may refer to a distance between centers of adjacent filter pieces 130, “x” may refer to a horizontal distance between edges of adjacent filter pieces 130 and “y” may refer to a vertical distance between edges of adjacent filter pieces 130, “A” may refer to an interior area of the filter pieces 130 and “F” may refer to an area of the filter pieces 130 including the edges.

Specifically, in the optical filter unit 114, the edges of the filter pieces 130 may at least partially be covered by the molded structure 140. In particular, the at least one molded structure 140 may cover potentially ragged and/or splintered edges, e.g. chipped edges, of the individual filter pieces 130.

### LIST OF REFERENCE NUMBERS

110 spectrometer device
112 optical detector
114 optical filter unit
116 evaluation device
118 housing
120 detector pixel
122 manufacturing method
124 step a)
126 layer of filter material
128 step b)
130 filter piece
132 step c)
134 carrier
136 step d)
138 step e)
140 molded structure
142 step f)
144 molded filter assembly
146 step g)
148 step h)
150 step i)
152 foil
154 carrier material

1. A method for manufacturing an optical filter unit for a spectrometer device, the method comprising:
a) providing at least one layer of a filter material;
b) generating individual filter pieces by singulating the layer of filter material into filter pieces;
c) providing a carrier;
d) picking the individual filter pieces and placing them on the carrier;
e) molding at least one moldable material at least partially onto the carrier with the individual filter pieces, thereby generating at least one molded structure with a predefined aperture and a predefined pitch between the individual filter pieces;
f) removing the carrier to generate a molded filter assembly; and
g) singulating the molded filter assembly into the at least one optical filter unit.

2. The method according to claim 1, wherein the individual filter pieces are singulated to have at least one predefined dimension.

3. The method according to claim 1, wherein the individual filter pieces are singulated by using at least one singulation method.

4. The method according to claim 3, wherein the at least one singulation method is selected from the group consisting of: mechanical dicing, sawing; cutting; laser dicing; plasma dicing; scribing; breaking; and combinations thereof.

5. The method according to claim 1, wherein step c) comprises generating the carrier by laminating a foil on a layer of carrier material.

6. The method according to claim 5, wherein the foil comprises at least one release material configured to allow a non-destructive separation of the carrier and the molded structure when removing the carrier in step f).

7. The method according to claim 1, wherein the individual filter pieces are placed on the carrier in a predefined arrangement and at a predefined distance between the individual filter pieces.

8. The method according to claim 1, wherein the molding process is selected from the group consisting of: cavity molding; injection molding; compression molding; selective melting; selective laser melting; exposed die molding, a transfer molding optionally in combination with a dynamic clamping, and combinations thereof.

9. The method according to claim 1, wherein between steps f) and g) the method further comprises:
h) molding at least one moldable material onto a side of the filter pieces previously covered by the carrier, thereby generating at least one second molded structure with a predefined aperture and a predefined pitch between the individual filter pieces.

10. The method according to claim 9, wherein before step h) the method further comprises:
i) flipping the molded structure with the individual filter pieces as generated in step e).

11. The method according to claim 1, wherein the molded structure is configured for at least one of blocking and absorbing electromagnetic radiation having a wavelength λ of 300 nm≤λ≤10 μm.

12. The method according to claim 1, wherein the at least one molded structure at least partially encloses the individual filter pieces.

13. The method according to claim 12, wherein the at least one molded structure covers potentially ragged and/or splintered edges of the individual filter pieces.

14. An optical detector for an optical detection of electromagnetic radiation in a predefined wavelength range of interest, the optical detector comprising:
at least one detector pixel; and
at least one optical filter unit manufactured according to the method of claim 1.

15. A spectrometer device comprising:
at least one optical detector according to claim 14; and
at least one evaluation device configured to generate at least one item of spectral information from at least one detector signal generated by the at least one optical detector from incident radiation.
